(19) United States
(12) Patent Application Publication
(10) Pub. No.: US 2021/0170714 A1
(43) Pub. Date: Jun. 10, 2021

(54) BONDED JOINT WITH SURFACE STRUCTURES AND METHODS OF PREPARING AND JOINING SAME

(71) Applicant: Bell Textron Inc., Fort Worth, TX (US)

(72) Inventors: Pier-Alexandre Pelletier, Montreal (CA); Richard Gingras, Montreal (CA)

(73) Assignee: Bell Textron Inc., Fort Worth, TX (US)

(21) Appl. No.: 17/112,667

(22) Filed: Dec. 4, 2020

Related U.S. Application Data
(60) Provisional application No. 62/943,345, filed on Dec. 4, 2019.

(51) Int. Cl. B32B 3/30; B32B 7/12; B32B 5/02; B32B 15/14; B32B 37/12; B32B 38/06; B32B 38/00

(52) U.S. Cl. CPC B32B 3/30; B32B 7/12; B32B 5/02; B32B 15/14; B32B 2310/0843; B32B 38/06; B32B 38/0012; B32B 2037/1253; B32B 2038/002; B32B 37/12

(57) ABSTRACT

A bonded part includes a first surface facing toward a second surface, and a cured adhesive between the first and second surfaces defining a bond line. A surface structure on the first surface is within the bond line and has surface protrusions arranged in a pattern. Each surface protrusion protrudes outwardly from a first end at the first surface to a second end adjacent to the second surface. A thickness of the surface protrusions is substantially equal to the thickness of the bond line. The cured adhesive extends around the surface protrusions. The thickness of the bond line between the first and second surfaces is substantially constant along the bond line, and is greater than a thickness of the cured adhesive between the second ends of the protrusions and the second surface.

### CROSS-REFERENCE TO RELATED APPLICATIONS

This application claims priority to U.S. provisional patent application 62/943,345 filed Dec. 4, 2019, the entire contents of which are incorporated by reference herein.

### TECHNICAL FIELD

The application relates generally to joints between components and, more particularly, to bonded joints.

### BACKGROUND

Parts can be joined together by being bonded with adhesives. To improve the bond between the parts, the areas or regions of the parts that will be bonded together may be treated. For example, the regions may be sandblasted to roughen the regions and prepare them to receive the adhesive. It may also be necessary to control the adhesive that will be placed between the parts, so as to control its adhesive abilities, its thickness, or its flow between the two parts. This control may be performed by adding different media to the adhesive, such as glass beads, scrim cloth, veil, threads, wire, mesh, etc. Once added to the adhesive, these media are permanently made part of the joint when the adhesive cures.

Adding such media may introduce discontinuities, local defects or impurities into the adhesive and joint. Adding such media to the adhesive is labor-intensive, manual and not easily repeatable.

### SUMMARY

There is disclosed a method of bonding components along a bond line, the bond line formed along a first surface of one of the components and a second surface on another one of the components facing the first surface, the method comprising: providing a surface structure on the first surface of the bond line, the surface structure having a plurality of surface protrusions arranged in a pattern and occupying an area of the first surface, each of the surface protrusions protruding outwardly from a first end at the first surface to a second end, a thickness of the surface protrusions defined between the first and second ends; applying an adhesive on one or both of the first and second surfaces along the bond line; joining the first and second surface surfaces together to bring the second ends of the surface protrusions in proximity to the second surface, the adhesive defining a thickness of the bond line being substantially equal to the thickness of the surface protrusions; and curing the adhesive between the joined first and second surfaces to bond the components along the bond line.

There is disclosed a method of preparing a surface of a component to be bonded with another surface of another component along a bond line, the method comprising: selecting a pattern of surface protrusions for the surface to define a thickness of the bond line; and providing the surface protrusions onto an area of the surface within the bond line.

There is disclosed a bonded part, comprising: a first component having a first surface facing toward a second surface of a second component; a cured adhesive between the first and second surfaces and defining a bond line, a thickness of the bond line defined between the first and second surfaces; a surface structure on the first surface within the bond line, the surface structure having a plurality of surface protrusions arranged in a pattern and occupying an area of the first surface, each of the surface protrusions protruding outwardly from a first end at the first surface to a second end adjacent to the second surface, a thickness of the surface protrusions defined between the first and second ends and being substantially equal to the thickness of the bond line; and the cured adhesive extending around the surface protrusions, the thickness of the bond line between the first and second surfaces being substantially constant along the bond line, and being greater than a thickness of the cured adhesive between the second ends of the protrusions and the second surface.

### DESCRIPTION OF THE DRAWINGS

Reference is now made to the accompanying figures in which:

FIG. 1A is a schematic cross-sectional view of a bonded joint, showing a bond line;

FIG. 1B is an enlarged view of a surface structure within the bond line of FIG. 1A;

FIG. 10 is an enlarged view of another surface structure within the bond line of FIG. 1A;

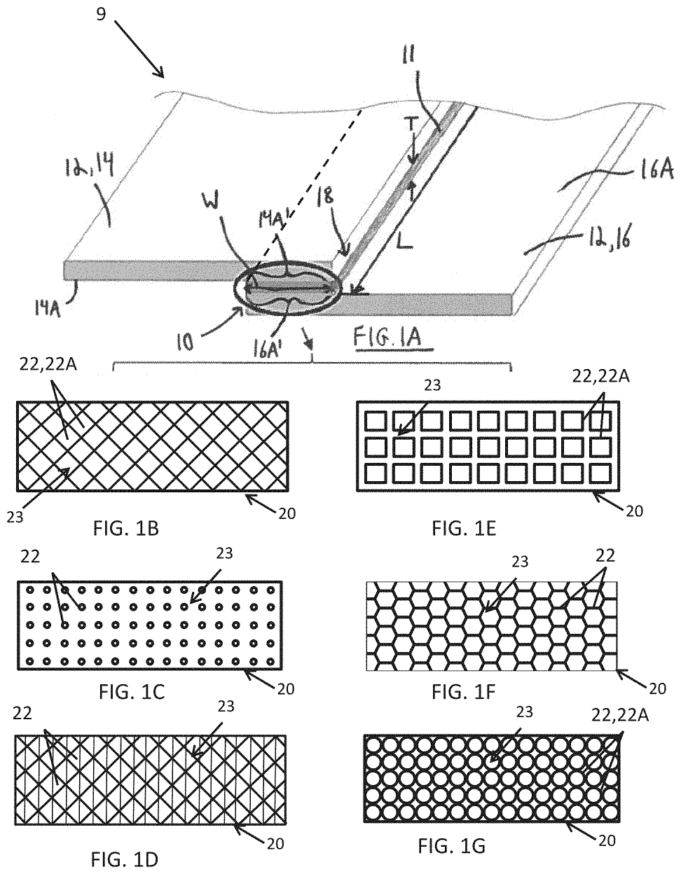

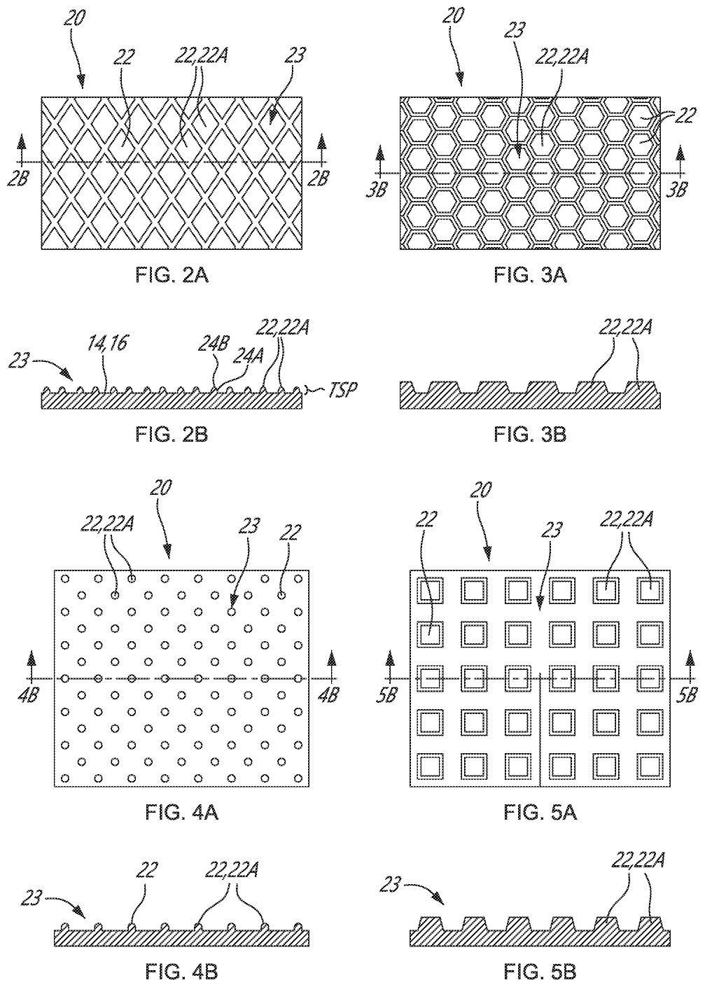

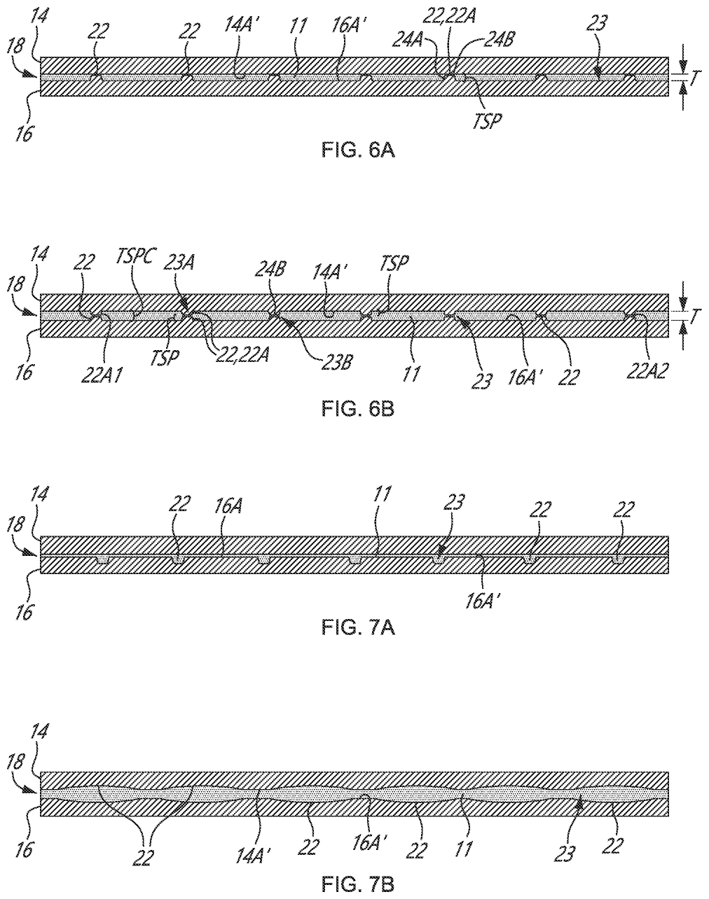

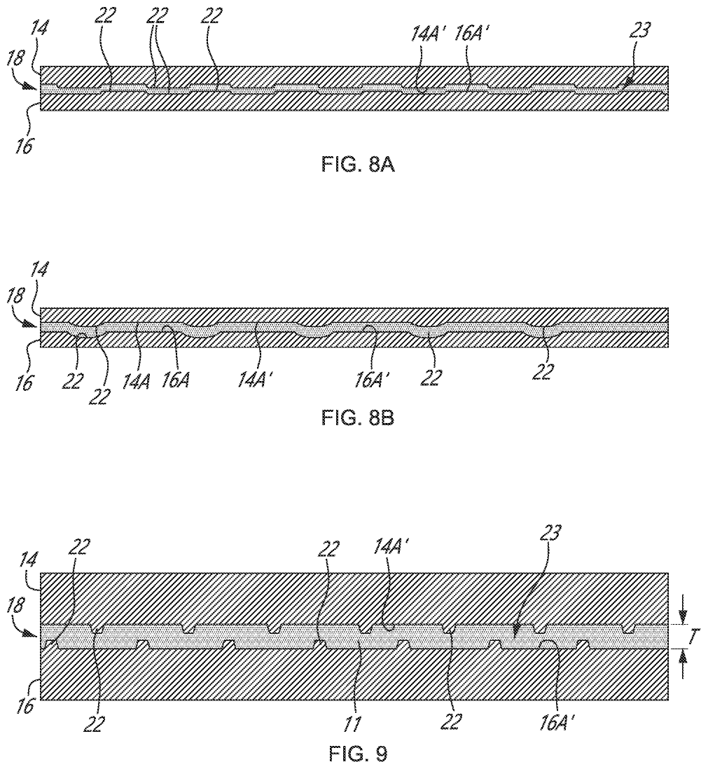

FIG. 1D is an enlarged view of another surface structure within the bond line of FIG. 1A;

FIG. 1E is an enlarged view of another surface structure within the bond line of FIG. 1A;

FIG. 1F is an enlarged view of another surface structure within the bond line of FIG. 1A;

FIG. 1G is an enlarged view of another surface structure within the bond line of FIG. 1A;

FIG. 2A is an enlarged view of another surface structure within the bond line of FIG. 1A;

FIG. 2B is a cross-sectional view of the surface structure of FIG. 2A;

FIG. 3A is an enlarged view of another surface structure within the bond line of FIG. 1A;

FIG. 3B is a cross-sectional view of the surface structure of FIG. 3A;

FIG. 4A is an enlarged view of another surface structure within the bond line of FIG. 1A;

FIG. 4B is a cross-sectional view of the surface structure of FIG. 4A;

FIG. 5A is an enlarged view of another surface structure within the bond line of FIG. 1A;

FIG. 5B is a cross-sectional view of the surface structure of FIG. 5A;

FIG. 6A is a schematic cross-sectional view of the bonded joint of FIG. 1A, showing a configuration of the surface structure of the bonded joint;

FIG. 6B is a schematic cross-sectional view of the bonded joint of FIG. 1A, showing another configuration of the surface structure of the bonded joint;

FIG. 7A is a schematic cross-sectional view of the bonded joint of FIG. 1A, showing another configuration of the surface structure of the bonded joint;

FIG. 7B is a schematic cross-sectional view of the bonded joint of FIG. 1A, showing another configuration of the surface structure of the bonded joint;

FIG. 8A is a schematic cross-sectional view of the bonded joint of FIG. 1A, showing another configuration of the surface structure of the bonded joint;

FIG. 8B is a schematic cross-sectional view of the bonded joint of FIG. 1A, showing another configuration of the surface structure of the bonded joint;

FIG. 9 is a schematic cross-sectional view of the bonded joint of FIG. 1A, showing another configuration of the surface structure of the bonded joint;

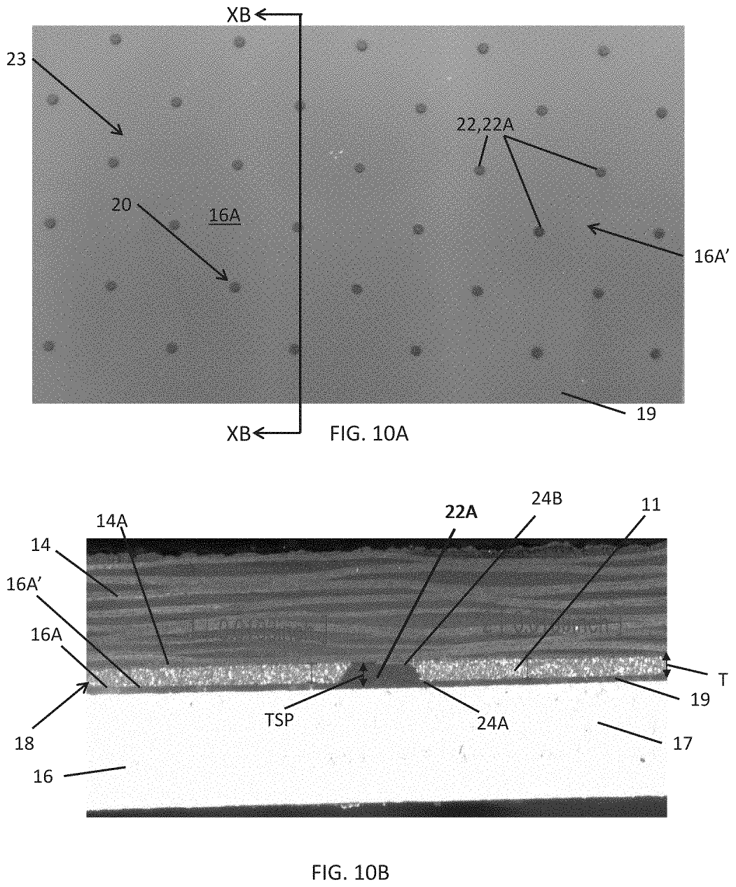

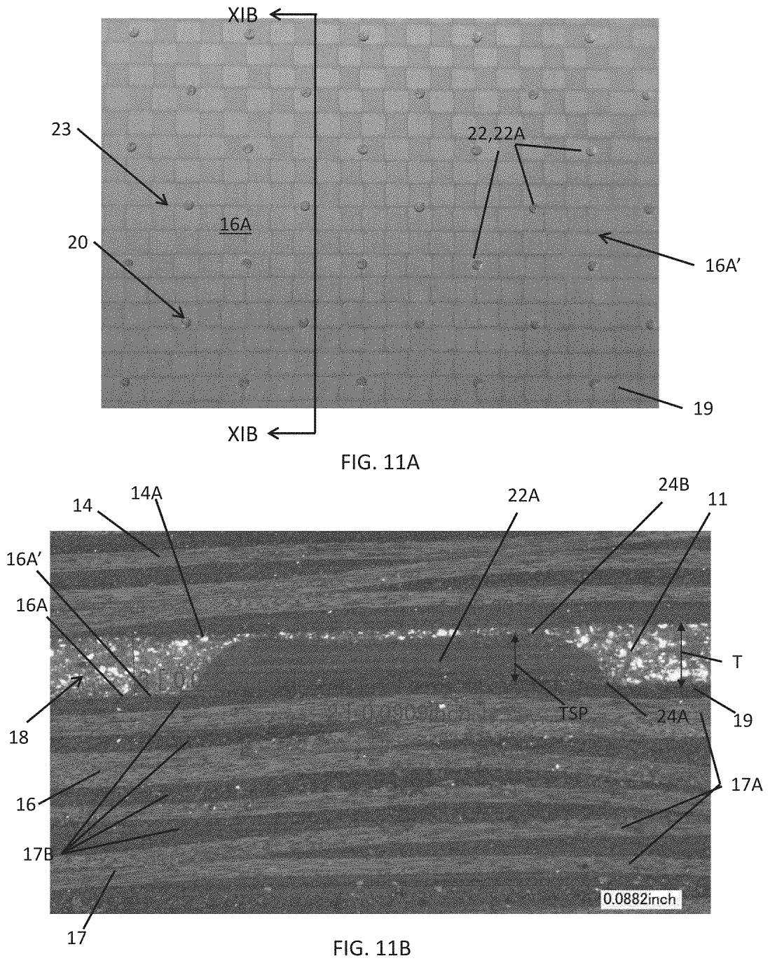

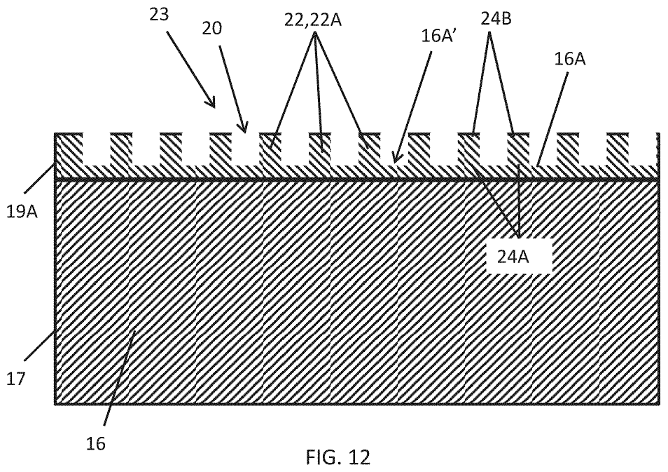

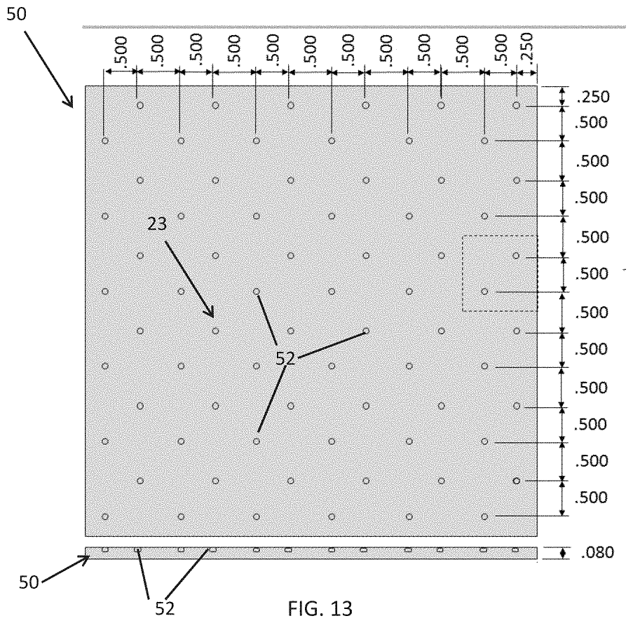

FIG. 10A is a top view of a component having another surface structure;

FIG. 10B is a cross-sectional view of the bonded joint of FIG. 1A, including a cross-sectional view of the component of FIG. 10A taken along the line XB-XB;

FIG. 11A is a top view of a component having another surface structure;

FIG. 11B is a cross-sectional view of the bonded joint of FIG. 1A, including a cross-sectional view of the component of FIG. 11A taken along the line XIB-XIB;

FIG. 12 is a cross-sectional view of the bonded joint of FIG. 1A; and

FIG. 13 is a schematic view of a tool used to form a surface structure of the bonded joint of FIG. 1A.

### DETAILED DESCRIPTION

FIG. 1A illustrates a part 9 formed between components 12. The part 9 has a bonded joint 10 formed between the components 12. The bonded joint 10 is a region or area of the components 12 along which they are joined to each other, such that the part 9 is a bonded part 9. In FIG. 1A, two components 12, specifically a first component 14 and a second component 16, are joined to each other along the bonded joint 10. In alternate embodiments, more than two components 12 are joined together at the bonded joint 10. For example, in one possible embodiment, three components 12 are joined together at the bonded joint 10. In another possible embodiment, two components 12 are joined together at the bonded joint 10 to form an assembly, and the assembly is itself joined to one or more other components 12 at another bonded joint 10 to form a multi-component stacked assembly. One or more of the components 12 may be planar or have a curvature. It will therefore be appreciated that many configurations for the bonded joint 10 and resulting bonded part 9 are within the scope of the present disclosure, and that the configuration of the bonded part 9 is therefore not limited to that shown in FIG. 1A. The components 12 may be any structure, or portions of structure, which are to be bonded together.

The bonded joint 10 includes mating surfaces of the components 12. In FIG. 1A, the first component 14 has a first surface 14A facing a second surface 16A of the second component 16. The first and second surfaces 14A,16A face each at least partially because the first and second components 14,16 are bonded together along part of the first and second surfaces 14A,16A. The first and second surfaces 14A,16A are spaced apart from each other, as described in greater detail below. In an alternate configuration, some or all of the first and second surfaces 14A,16A abut directly. In FIG. 1A, the bonded joint 10 includes only an area or portion 14A′ of the first surface 14A, and only an area or portion 16A′ of the second surface 16A. The portions 14A′,16A′ of the first and second surfaces 14A,16A are those which mate with each other. The portions 14A′,16A′ of the first and second surfaces 14A,16A are those along which the bonding of the first and second components 14,16 will occur. The portions 14A′,16A′ of the first and second surfaces 14A,16A are less than an entirety of the first and second surfaces 14A,16A in FIG. 1A. In an alternate embodiment, the bonded joint 10 includes all of the first surface 14A and all of the second surface 16A. The use of “first” and “second” to describe the surfaces 14A,16A does not limit the bonded joint 10 to being between only two surfaces. The bonded joint 10 requires a minimum of two surfaces bonded together, and may include more than two surfaces bonded together. In FIG. 1A, the first and second components 14,16 are separate and distinct from one another, and thus define respective first and second surfaces 14A,16A which are separate and distinct from each other before being bonded. In an alternate embodiment, the first and second surfaces 14A,16A are portions of the same surface of the same component 12, which are folded towards each other and bonded together. In such an embodiment, the components 12 are not separate from one another, and are instead portions of the same component 12.

Referring to FIG. 1A, the bonded part 9 includes an adhesive 11 forming part of the bonded joint 10. The adhesive 11 extends between the first and second components 12,14 and joins them together along the portions 14A′,16A′ of the first and second surfaces 14A,14B. In FIG. 1A, the adhesive 11 is shown in its dried or cured form, and it will be appreciated that it may applied while it is in a flowable or uncured form to wet the portions 14A′,16A′ of the first and second surfaces 14A,16A. In FIG. 1A, the adhesive 11 is a layer of resin.

The components 12 are joined together along a bond line 18. The bond line 18 is part of the bonded joint 10, and is a region of the first and second surfaces 14A,16A along which the components 12 are joined together. The bond line 18 is defined by overlapping portions. Referring to FIG. 1A, the bond line 18 extends over the area of the portion 14A′ of the first surface 14A that is overlapped by, or facing, the portion 16A′ of the second surface 16A, and vice versa. The bond line 18 refers to where the adhesive 11 contacts and engages the components 12. The bond line 18 is partly defined by the extent of the cured adhesive 11. The bond line 18 has a three-dimensional extent. The bond line 18 has a thickness T that is measured in a direction perpendicular to the first and second surfaces 14A,16A. In FIG. 1A, the thickness T of the bond line 18 is substantially equal to the thickness of part of the layer of cured adhesive 11. The thickness of the adhesive 11 may vary, as described in greater detail below. The bond line 18 has a width W measured in a direction parallel to the first and second surfaces 14A,16A, and to the dotted line shown in FIG. 1A. The bond line 18 has a length L measured in a direction parallel to the first and second surfaces 14A,16A, and perpendicular to the direction along which the width W is measured.

Referring to FIG. 1B, the bonded part 9 includes a surface structure 20 on one or more of the mating surfaces 14A,16A within the bond line 18. The surface structure 20 is an arrangement of elements or features along only the surface of one or more of the components 12. The surface structure 20 does not form part of the underlying geometry of the component 12. The surface structure 20 is selected or designed in advance, and then applied to the surface to impact a property of the bond along the bond line 18. The application of the surface structure 20 to the component 12 leaves unchanged the underlying geometry and properties of the component 12. Thus, if the component 12 treated to receive the surface structure 20, it will not result in a modification of the component 12 itself. The surface structure 20 is part of, or located within, the bond line 18. The widthwise and lengthwise extent of the surface structure 20 thus overlaps, or is within, the widthwise and lengthwise extent of the bond line 18. When the components 12 are bonded together, the surface structure 20 is covered with the adhesive 11.

The surface structure 20 includes a plurality of structural surface features 22. The structural surface features 22 are physical objects or formations along one or both of the mating surfaces of the bonded joint 10, which are selected and applied to the mating surface in advance of forming the bond joint 10 to impact a property of the bond line 18. Examples of some possible structural surface features 22 within the scope of the present disclosure are provided below. The structural surface features 22 are arranged in a pattern 23 to achieve the desired impact on the bond line 18. The pattern 23 of the structural surface features 22 repeats over an area of the surface. The pattern 23 is a repeating design of the structural surface features 22 themselves and/or a repeating arrangement of the structural surface features 22. The pattern 23 is planned and systemic. The pattern 23 is not random. The pattern 23 occupies some or all of the area of one or more of the mating surfaces 14A,16A. For example, the pattern 23 may occupy some or all of the area of the portion 14A′ of the first surface 14A and/or some or all of the area of the portion 16A′ of the second surface 16A. In FIG. 1A, the pattern 23 of the structural surface features 22 is applied to only those portions 14A′,16A′ of the first and second surfaces 14A,16A which mate with each other, and which form the interface of the bonded joint 10. In an alternate embodiment, the pattern 23 of the structural surface features 22 is applied to more of the first and second surfaces 14A,16A. In an embodiment, the pattern 23 of the structural surface features 22 is applied to only those portions 14A′,16A′ of the first and second surfaces 14A,16A which engage with the adhesive 11.

The pattern 23 of the structural surface features 22 thus helps to create a special or unique surface design for one or more of the mating surfaces of the components 12. The one or more of the mating surfaces 14A,16A are thus “engineered” or designed to impact the bond between the components 12, typically to improve a property of the bond line 18. For example, and as will be described in greater detail below, the pattern 23 of the structural surface features 22 may be selected to improve one or more of the following properties of the bond line 18, in any combination: the mechanical interlocking between the mated surfaces, the alignment of the mated surfaces, the flow of the adhesive 11 between the surfaces, the thickness T of the bond line 18, and the wetting of the surfaces 14A,16A.

The structural surface features 22 may be raised above or formed below the remainder of the mating surface. The pattern 23 may repeat throughout the entirety of the area of the mating surface or be present in only one portion. The shape of each structural surface feature 22 may vary and include one or more of the following possible shapes, in any combination: circular, cylindrical, square, diamond, hexagonal, etc. Thus, many patterns 23 of the structural surface features 22 are possible and within the scope of the present disclosure. Non-limiting examples of possible patterns 23 of the structural surface features 22 are described in greater detail below with reference to FIGS. 1B to 1G. The size or scale of the structural surface features 22 in the pattern 23 may vary. For example, in one possible configuration, the structural surface features 22 are cylindrical or tubular protrusions extending from one or both of the mating surfaces 14A,16A which have a diameter of about 75 thou (i.e., thousandths of an inch) and a length or height of about 5-10 thou. In such a configuration, the structural surface features 22 are spaced apart from each other by about 500 thou. The pattern 23 of the structural surface features 22 is visible to the naked eye in some embodiments. The structural surface features 22 may be in the range of the millimeter scale.

The pattern 23 shown in FIG. 1B is now described in greater detail. The pattern 23 of the surface structure 20 includes structural surface protrusions 22A that are symmetric. In the area of the mating surface that is occupied by the pattern 23, the surface protrusions 22A are exactly the same around different lines which form different axes of symmetry. The surface protrusions 22A are arranged in parallel within the pattern 23. The surface protrusions 22A are arranged throughout the pattern 23 to have an orientation that is parallel to one or more both of the length L and width W of the bond line 18. The surface protrusions 22A repeat throughout the pattern 23. One of the surface protrusions 22A is repeated over the area of the mating surface to define the pattern 23. The same surface protrusion 22A is repeated and used throughout the area of the mating surface to define the pattern 23. In FIG. 1B, two or more of the surface protrusions 22A are also repeated over the area of the mating surface 22 to define the pattern 23. Thus, the pattern 23 may be defined by the repetition or replication of one surface protrusion 22A, or by the repetition or replication of two or more surface protrusions 22A. The surface protrusions 22A include rectangular-shaped elements extending outwardly from the mating surface. The distal extremities of the rectangular-shaped elements are out of plane with the remainder of the mating surface. The distal extremities of the rectangular-shaped elements are raised relative to the remainder of the mating surface.

The pattern 23 shown in FIG. 10 is now described in greater detail. The pattern 23 of the surface structure 20 includes structural surface features 22 that are symmetric. The structural surface features 22 are arranged in parallel within the pattern 23. The structural surface features 22 repeat throughout the pattern 23. In FIG. 10, the pattern 23 is defined by the repetition or replication of one structural surface feature 22, or by the repetition or replication of two or more structural surface features 22. The structural surface features 22 include circular depressions or indentations extending into the mating surface. The mating surface is raised relative to a bottom of the circular depressions. In an alternate embodiment, the structural surface features 22 include circular protrusions or mounds extending from the mating surface. The mating surface is flat and planar below a summit of the circular protrusions.

The pattern 23 shown in FIG. 1D is now described in greater detail. The pattern 23 of the surface structure 20 includes structural surface features 22 that are symmetric. The structural surface features 22 are arranged in parallel within the pattern 23. The structural surface features 22 repeat throughout the pattern 23. In FIG. 1D, the pattern 23 may be defined by the repetition or replication of one structural surface feature 22, or by the repetition or replication of two or more structural surface features 22. The structural surface features 22 include pyramid-shaped elements, which extend outwardly from the mating surface to an apex of each pyramid-shaped element. The direction of extension from the mating surface of the pyramid-shaped elements is toward the other mating surface. The apex of the pyramid-shaped elements is spaced above, or apart, from the mating surface.

The pattern 23 shown in FIG. 1E is now described in greater detail. The pattern 23 of the surface structure 20 includes surface protrusions 22A that are symmetric. The surface protrusions 22A are arranged in parallel within the pattern 23. The surface protrusions 22A repeat throughout the pattern 23. In FIG. 1E, the pattern 23 may be defined by the repetition or replication of one surface protrusion 22A, or by the repetition or replication of two or more surface protrusions 22A. The surface protrusions 22A include rectangular-shaped elements, which extend outwardly from the mating surface to a plateau of each rectangular-shaped element. The direction of extension from the mating surface of the rectangular-shaped elements is toward the other mating surface. The plateau of the rectangular-shaped elements is spaced above, or apart, from the mating surface. Channels or grooves are defined between the raised rectangular-shaped elements. The channels have a height measured from the mating surface to the plateaus of the rectangular-shaped elements.

The pattern 23 shown in FIG. 1F is now described in greater detail. The structural surface features 22 are arranged in parallel within the pattern 23. The structural surface features 22 repeat throughout the pattern 23. In FIG. 1F, the pattern 23 may be defined by the repetition or replication of one structural surface feature 22, or by the repetition or replication of two or more structural surface features 22. The structural surface features 22 include hexagonal-shaped elements, which extend outwardly from the mating surface. The direction of extension from the mating surface of the hexagonal-shaped elements is toward the other mating surface. The summit of the hexagonal-shaped elements is spaced above, or apart, from the mating surface.

The pattern 23 shown in FIG. 1G is now described in greater detail. The pattern 23 of the surface structure 20 includes surface protrusions 22A that are symmetric. The surface protrusions 22A are arranged in parallel within the pattern 23. The surface protrusions 22A repeat throughout the pattern 23. In FIG. 1F, the pattern 23 may be defined by the repetition or replication of one surface protrusion 22A, or by the repetition or replication of two or more surface protrusions 22A. The surface protrusions 22A include first rounded elements, which extend outwardly from the mating surface, and second rounded elements mounted on top of each of the first rounded elements and which also extend outwardly from the mating surface. The direction of extension from the mating surface of the first and second rounded elements is toward the other mating surface. The tops of the first and second rounded elements are spaced above, or apart, from the mating surface. Channels or grooves are defined between the raised first and second rounded elements. The channels have a height measured from the mating surface to the tops of the first and second rounded elements.

The pattern 23 shown in FIGS. 2A and 2B is now described in greater detail. The pattern 23 of the surface structure 20 includes structural surface protrusions 22A that are symmetric. In the area of the mating surface that is occupied by the pattern 23, the surface protrusions 22A are exactly the same around different lines which form different axes of symmetry. The surface protrusions 22A are arranged in parallel within the pattern 23. The surface protrusions 22A repeat throughout the pattern 23. One of the surface protrusions 22A is repeated over the area of the mating surface to define the pattern 23. The same surface protrusion 22A is repeated and used throughout the area of the mating surface to define the pattern 23. In FIGS. 2A and 2B, two or more of the surface protrusions 22A are also repeated over the area of the mating surface 22 to define the pattern 23. Thus, the pattern 23 may be defined by the repetition or replication of one surface protrusion 22A, or by the repetition or replication of two or more surface protrusions 22A.

The surface protrusions 22A are extensions from the mating surface 14A,16A shown in FIGS. 2A and 2B. Each surface protrusion 22A extends from a first end 24A that is at the mating surface 14A,16A, to a distal second end 24B that is spaced apart from the first end 24A. In FIGS. 2A and 2B, each surface protrusion 22A is a solid or filled body. The second end 24B of each surface protrusion 22A is out of plane with the remainder of the mating surface 14A,16A. The second ends 24B are spaced from the remainder of the mating surface 14A,16A. The second ends 24B of the surface protrusions 22A lie in the same plane spaced apart from a plane of the remainder of mating surface 14A,16A around the surface protrusions 22A. Referring to FIGS. 2A and 2B, the surface protrusions 22A include parallelogram-shaped elements extending outwardly from the mating surface 14A,16A. A height or thickness TSP of each surface protrusion 22A is measured from the first end 24A to the second end 24B.

The pattern 23 shown in FIGS. 3A and 3B is now described in greater detail. The surface protrusions 22A repeat throughout the pattern 23. In FIGS. 3A and 3B, the pattern 23 may be defined by the repetition or replication of one surface protrusion 22A, or by the repetition or replication of two or more surface protrusions 22A. The surface protrusions 22A include hexagonal or honeycomb shaped elements, which extend outwardly from the mating surface. In the cross-sectional view of FIG. 3B, the projecting honeycomb elements have a trapezoidal cross-sectional shape. The direction of extension from the mating surface of the honeycomb-shaped elements is toward the other mating surface. The summit of the honeycomb-shaped elements is spaced above, or apart, from the mating surface. The honeycomb-shaped elements are hollow.

The pattern 23 shown in FIGS. 4A and 4B is now described in greater detail. The pattern 23 of the surface structure 20 includes surface protrusions 22A that are symmetric. The surface protrusions 22A are arranged in parallel within the pattern 23. The surface protrusions 22A repeat throughout the pattern 23. In FIGS. 4A and 4B, the pattern 23 is defined by the repetition or replication of one surface protrusion 22A, or by the repetition or replication of two or more surface protrusions 22A. The surface protrusions 22A include circular protrusions or dots extending from the mating surface. The mating surface is beneath the summit of the circular protrusions. The circular protrusions are full-bodied. The circular protrusions are not hollow. The circular protrusions may have a density in the pattern 23 of about 5 per square inch.

The pattern 23 shown in FIGS. 5A and 5B is now described in greater detail. The pattern 23 of the surface structure 20 includes surface protrusions 22A that are symmetric. The surface protrusions 22A are arranged in parallel within the pattern 23. The surface protrusions 22A repeat throughout the pattern 23. In FIGS. 5A and 5B, the pattern 23 may be defined by the repetition or replication of one surface protrusion 22A, or by the repetition or replication of two or more surface protrusions 22A. The surface protrusions 22A include truncated pyramidal-shaped elements, which extend outwardly from the mating surface to a plateau of each truncated pyramidal-shaped element. The direction of extension from the mating surface of the truncated pyramidal-shaped elements is toward the other mating surface. The plateau of the truncated pyramidal-shaped elements is spaced above, or apart, from the mating surface. Channels or grooves are defined between the raised truncated pyramidal-shaped elements. The channels have a height measured from the mating surface to the plateaus of the truncated pyramidal-shaped elements. The truncated pyramidal-shaped elements are full-bodied. The truncated pyramidal-shaped elements are not hollow.

Non-limiting examples of additional possible patterns 23 of the structural surface features 22, as well as their anticipated impact on the bond or a property of the bond along the bond line 18, are described in greater detail below.

The pattern 23 of the bond line 18 shown in FIG. 6A is now described in greater detail. The pattern 23 and the structural surface features 22 are “one-sided”, and is present on only the portion 16A′ of the second surface 16A of the second component 16. The portion 14A′ of the first surface 14A of the first component 14 is free of a pattern 23. The portion 14A′ of the first surface 14A of the first component 14 is flat. The structural surface features 22 of the pattern 23 in the portion 16A′ of the second surface 16A are surface protrusions 22A extending outwardly from the first end 24A at the second surface 16A toward the second end 24B near the first surface 14A, and being separate from the first surface 14A. The second ends 24B of the surface protrusions 22A are spaced apart from the first surface 14A. The surface protrusions 22A are spaced apart from one another along the width W of the bond line 18. The surface protrusions 22A are spaced apart from one another some or all of the length L of the bond line 18. Channels are defined between the surface protrusions 22A. The channels have a height measured from the portion 16A′ of the second surface 16A to the second ends 24B of the surface protrusions 22A. The surface protrusions 22A are arranged in parallel within the pattern 23. The surface protrusions 22A repeat throughout the pattern 23.

Referring to FIG. 6A, the structural surface protrusions 22A are cylindrical or tubular protrusions extending from only the second surface 16A. The diameter of the cylindrical surface protrusions 22A may be about 75-100 thou, and may have a length or height of about 5-10 thou. The structural surface protrusions 22A may be spaced apart from each other by about 500 thou. The pattern 23 of the surface protrusions 22A is visible to the naked eye in FIG. 6A.

In FIG. 6A, the thicknesses TSP of the surface protrusions 22A are substantially constant along the bond line 18. It is meant by “substantially constant” that the thicknesses TSP of the surface protrusions 22A do not vary, or vary slightly by an acceptable manufacturing deviation. The surface structure 20 in FIG. 6A thus has a fixed or constant height and repeated pattern, which may facilitate obtaining a constant thickness T for the bond line 18. In an alternate configuration, the thicknesses TSP of the surface protrusions 22A varies such that some surface protrusions 22A are substantively thicker than others. The thicker surface protrusions 22A in this configuration are positioned adjacent to, or in abutment with, the first surface 14A, whereas the thinner or “shorter” surface protrusions 22A are present to increase the adhesive surface area within the bond line 18.

The pattern 23 of the structural surface features 22 shown in FIG. 6A is selected and applied to the portion 16A′ of the second surface 16A to help control the thickness T of the bond line 18. The thickness TSP of each surface protrusion 22A is substantially equal to the thickness T of the bond line 18. It is meant by “substantially equal” that the thickness TSP of each surface protrusion 22A is identical to the thickness T of the bond line 18 at the location of a given surface protrusion 22A, or differs slightly from the thickness T of the bond line 18 by an acceptable manufacturing deviation. For example, and referring to FIG. 6A, the second ends 24B of one or more of the surface protrusions 22A are spaced apart from the first surface 14A a distance less than the thickness TSP of the surface protrusion 22A.

The thickness T of the bond line 18 between the first and second surfaces 14A,16A is substantially constant along the bond line 18. It is meant by “substantially constant” that the thickness T of the bond line 18 does not change between the first and second surfaces 14A,16A, or varies slightly by an acceptable manufacturing deviation. The cured adhesive 11 is present around the surface protrusions 22A. The thickness of the cured adhesive 11 varies in FIG. 6A. In the portions of the bond line 18 that are between the surface protrusions 22A, the thickness of the cured adhesive 11 is substantially equal to the thickness T of the bond line 18. In the portions of the bond line 18 that are between the surface protrusions 22A, the thickness of the cured adhesive 11 is identical to the thickness TSP of the surface protrusions 22A. In FIG. 6A, where the second ends 24B of the surface protrusions 22A are spaced apart from the first surface 14A, the thickness of the cured adhesive 11 is less than the thickness T of the bond line 18 in the regions of the bond line 18 that are between the second ends 24B of the surface protrusions 22A and the first surface 14A.

As the first and second components 14,16 are brought together to be bonded, the first component 14 is prevented from being displaced past the surface protrusions 22A because of their thickness TSP, thereby ensuring a minimum thickness T for the bond line 18. Thus, in FIG. 6A, the pattern 23 of the structural surface features 22 is selected to control or determine the thickness T of the bond line 18, which may help to ensure optimal mechanical properties for the bonded joint 10. The pattern 23 of surface protrusions 22A in FIG. 6A allows for controlling the thickness T of the bond line 18 by modifying or adapting the surface geometry of only one of the surfaces of one of the components 14,16. The pattern 23 of the structural surface features 22 in FIG. 6A also allows for controlling or determining the thickness T of the bond line 18 without having to use accessories or additives that are not structurally needed for the bonded part 9, such as glass beads, scrim cloth, veil, threads, wire, mesh, etc. Thus, the pattern 23 of the structural surface features 22 in FIG. 6A may allow for replacing or eliminating conventional bond line fillers with a pattern 23 on the surface of one or more of the bonded components 14,16. The pattern 23 of the structural surface features 22 in FIG. 6A may also allow for determining or maintaining a thickness T for the bond line 18 that remains constant throughout the bond line 18 because of the constant thickness TSP of the surface protrusions 22A. Such a control of the thickness T of the bond line 18 may allow for controlling the flow of adhesive 11 between the components 14,16. In an alternative configuration, in addition to the pattern 23 of the structural surface features 22, the bond line 18 may have one or more fillers or media.

The pattern 23 of the bond line 18 shown in FIG. 6B is now described in greater detail. The pattern 23 and its structural surface features 22 are “two-sided”, and are present on both the portion 16A′ of the second surface 16A of the second component 16 and on the portion 14A′ of the first surface 14A of the first component 14. The bond line 18 in FIG. 6B thus has a first pattern 23A with first surface protrusions 22A1 on the first surface 14A, and a second pattern 23B with second surface protrusions 22A2 on the second surface 16A. Both the first and second surface protrusions 22A1,22A2 extend outwardly from their respective surfaces 14A,16A on one of the components 14,16 toward the other surface 14A,16A of the other component 14,16. The first and second surface protrusions 22A1,22A2 are spaced apart from one another on their respective surface 14A,16A along the width W of the bond line 18. The first and second surface protrusions 22A1,22A2 are spaced apart from one another on their respective surfaces 14A,16A along some or all of the length L of the bond line 18. Channels are defined between the first and second surface protrusions 22A1,22A2 on each surface 14A,16A. The channels have a height measured from the portions 14A′,16A′ of the first and second surfaces 14A,16A to the second ends 24B of the first and second surface protrusions 22A1,22A2. The first and second surface protrusions 22A1,22A2 are arranged in parallel within the first and second patterns 23A,23B. The first and second surface protrusions 22A1,22A2 repeat throughout the first and second patterns 23A,23B. In FIG. 6B, the first and second patterns 23A,23B of surface protrusions 22A are the same. In an alternate configuration, the first and second patterns 23A,23B of surface protrusions 22A are different. The description of the surface protrusions 22A, their thicknesses TSP, the thickness T of the bond line 18, and the thickness of the cured adhesive 11 provided above in reference to FIG. 6A applies mutatis mutandis to those same features shown in FIG. 6B.

Referring to FIG. 6B, the second ends 24B of the first and second surface protrusions 22A1,22A2 face each other and are in close proximity. The first and second surface protrusions 22A1,22A2 are aligned along a direction that is parallel to the thickness T of the bond line 18. In FIG. 6B, the first and second surface protrusions 22A1,22A2 are aligned such that there is no nesting between the first and second components 14,16. The second ends 24B of the first and second surface protrusions 22A1,22A2 are spaced apart from each to define a gap between the aligned second ends 24B. The size of the gap is small in comparison to the thickness T of the bond line 18. For example, the second ends 24B are spaced apart from each other a distance less than the thicknesses TSP of the first and second surface protrusions 22A1,22A2. In FIG. 6B, the thicknesses TSP of the first surface protrusions 22A1 is the same as the thicknesses TSP of the second surface protrusions 22A2. In an alternate configuration, the thicknesses TSP of the first and second surface protrusions 22A1,22A2 are different. In an alternate configuration, the gap between the aligned second ends 24B is zero, such that the second ends 24B of the first and second surface protrusions 22A1,22A2 are in abutting contact. In an alternate configuration, the first and second surface protrusions 22A1,22A2 are misaligned and the thickness TSP of the second surface protrusions 22A2 is greater than the thickness of the first surface protrusion 22A1, such that the thicker second surface protrusions 22A2 help define the thickness T of the bond line 18 and the thinner or shorter first surface protrusions 22A1 are present to increase the adhesive surface area within the bond line 18.

Referring to FIG. 6B, the thickness T of the bond line 18 is substantially equal to the combined thickness TSPC of the first and second surface protrusions 22A1,22A2. It is meant by “substantially equal” that the combined thickness TSPC of the first and second surface protrusions 22A1,22A2 is identical to the thickness T of the bond line 18 at the location of an aligned pair of the first and second surface protrusions 22A1,22A2, or differs slightly from the thickness T of the bond line 18 by an acceptable manufacturing deviation. The thickness T of the bond line 18 may thus be defined by surface structure 22 on each of the first and second components 14,16 forming the bonded part 9.

As the first and second components 14,16 are brought together to be bonded in FIG. 6B, the first component 14 is prevented from being displaced past the second surface protrusions 22A2 of the second component 16 because of their thickness TSP, and the second component 16 is prevented from being displaced past the first surface protrusions 22A1 of the first component 14 because of their thickness TSP, thereby ensuring a minimum thickness T for the bond line 18. Thus, in FIG. 6B, the pattern 23 of the structural surface features 22 is selected to control or determine the thickness T of the bond line 18, which may help to ensure optimal mechanical properties for the bonded joint 10. The pattern 23 of first and second surface protrusions 22A1,22A2 in FIG. 6B allows for controlling the thickness T of the bond line 18 by modifying or adapting the surface geometry of both surfaces 14A,16A of both components 14,16. The first and second patterns 23A,23B of structural surface features 22 in FIG. 6B also allows for controlling or determining the thickness T of the bond line 18 without having to use accessories or additives that are not structurally needed for the bonded part 9, such as glass beads, scrim cloth, veil, threads, wire, mesh, etc. Thus, the first and second patterns 23A,23B of the structural surface features 22 in FIG. 6B may allow for replacing or eliminating conventional bond line fillers with patterns 23A,23B on both surfaces 14A,16A of the bonded components 14,16. The first and second patterns 23A,23B of the structural surface features 22 in FIG. 6B may also allow for determining or maintaining a thickness T for the bond line 18 that remains constant throughout the bond line 18 because of the combined constant thickness TSPC of the first and second surface protrusions 22A1,22A2. Such a control of the thickness T of the bond line 18 may allow for controlling the flow of adhesive 11 between the components 14,16.

The pattern 23 of the bond line 18 shown in FIG. 7A is now described in greater detail. The pattern 23 is “one-sided”, and is present on only the portion 16A′ of the second surface 16A of the second component 16. The portion 14A′ of the first surface 14A of the first component 14 is free of a pattern 23. The structural surface features 22 of the pattern 23 in the portion 16A′ of the second surface 16A are grooves extending inwardly into the second surface 16A. The grooves are spaced apart from one another along the width W of the bond line 18. The grooves extend along some or all of the length L of the bond line 18. The grooves are arranged in parallel within the pattern 23. The grooves repeat throughout the pattern 23. The pattern 23 of the structural surface features 22 shown in FIG. 7A is selected and applied to the portion 16A′ of the second surface 16A to help control the flow of the adhesive 11 through the bond line 18. As the first and second components 14,16 are brought together to be bonded, the adhesive 11 is squeezed and displaced through the bond line 18. The pattern 23 shown in FIG. 7A is selected to increase the rate of flow of the adhesive 11. This may allow for using an adhesive 11 that has a high viscosity in the bond joint 10, which is typically avoided because of the difficulty in applying such a high-viscosity adhesive 11. This may also allow for avoiding the use of a low-viscosity adhesive 11, which is typically used because of the ease by which it can be applied, but which creates overflow issues.

The pattern 23 of the bond line 18 shown in FIG. 7B is now described in greater detail. The pattern 23 is “two-sided”, and is present on both the portion 16A′ of the second surface 16A of the second component 16 and on the portion 14A′ of the first surface 14A of the first component 14. The structural surface features 22 of the pattern 23 are grooves extending inwardly into the second surface 16A, and inwardly into the first surface 14A. The grooves are spaced apart from one another along the width W of the bond line 18. The grooves extend along some or all of the length L of the bond line 18. The grooves are arranged in parallel within the pattern 23. The grooves repeat throughout the pattern 23. The pattern 23 of the structural surface features 22 shown in FIG. 7B is selected to help control the flow of the adhesive 11 through the bond line 18. As the first and second components 14,16 are brought together to be bonded, the adhesive 11 is squeezed and displaced through the bond line 18. The pattern 23 shown in FIG. 7B is selected to decrease the rate of flow the adhesive 11. The deep and wide grooves of the pattern 23 help to prevent the adhesive 11 from flowing out of the bond line 18. This may help to improve adhesion. Limiting the flow of the adhesive 11 using this surface pattern 23 may help to reduce squeeze-out, which impacts the quantity of adhesive 11 required and the operations to clean the excess adhesive 11 or remove the cured adhesive 11 after squeeze-out.

The pattern 23 of the bond line 18 shown in FIG. 8A is now described in greater detail. The pattern 23 is “two-sided”, and is present on both the portion 16A′ of the second surface 16A of the second component 16 and on the portion 14A′ of the first surface 14A of the first component 14. The structural surface features 22 of the pattern 23 include first protrusions extending outwardly from the second surface 16A toward the first surface 14A, and first grooves extending inwardly into the second surface 16A. The structural surface features 22 of the pattern 23 also include second protrusions extending outwardly from the first surface 14A toward the second surface 16A, and second grooves extending inwardly into the first surface 14A. The protrusions and grooves are spaced apart from one another along the width W of the bond line 18. The protrusions and grooves extend along some or all of the length L of the bond line 18. The protrusions and grooves are arranged in parallel within the pattern 23. The protrusions and grooves repeat throughout the pattern 23. The first protrusions are aligned with the second grooves, and the second protrusions are aligned with the first grooves. The first protrusions are offset along a direction of the width W from the second protrusions, and the first grooves are offset along a direction of the width W from the second grooves. The pattern 23 of the structural surface features 22 shown in FIG. 8A is selected and applied to the portions 14A′,16A′ to help with interlocking of the portions 14A′,16A′ and alignment along the bond line 18. As the first and second components 14,16 are brought together to be bonded, the first protrusions are moved into the second grooves and the second protrusions are moved into the first grooves. This mechanical interlocking of the first and second components 14,16 may improve their resistance to separation due to the shear forces, and may improve the alignment of the bonded joint 10. This mechanical interlocking of the first and second components 14,16 may also reinforce the bonded joint 10 against compressive forces, or tensile forces. Thus, in FIG. 8A, the surface pattern 23 may increase mechanical adhesion due to the structural surface features 22 increasing mechanical interlocking in the bonded joint 10.

The pattern 23 of the bond line 18 shown in FIG. 8B is now described in greater detail. The pattern 23 is “two-sided”, and is present on both the portion 16A′ of the second surface 16A of the second component 16 and on the portion 14A′ of the first surface 14A of the first component 14. The structural surface features 22 of the pattern 23 include protrusions extending outwardly from the first surface 14A toward the second surface 16A, and grooves extending inwardly into the second surface 16A. The protrusions and grooves are spaced apart from one another along the width W of the bond line 18. The protrusions and grooves extend along some or all of the length L of the bond line 18. The protrusions and grooves are arranged in parallel within the pattern 23. The protrusions and grooves repeat throughout the pattern 23. The protrusions are aligned with the grooves. The pattern 23 of the structural surface features 22 shown in FIG. 8B is selected and applied to the portions 14A′,16A′ to help with interlocking of the portions 14A′,16A′ and alignment along the bond line 18. As the first and second components 14,16 are brought together to be bonded, the protrusions are moved into the grooves. This mechanical interlocking of the first and second components 14,16 may improve their resistance to separation due to the shear forces, and may improve the alignment of the bonded joint 10. This mechanical interlocking of the first and second components 14,16 may also reinforce the bonded joint 10 against compressive forces, or tensile forces. Thus, in FIG. 8B, the surface pattern 23 may increase mechanical adhesion due to the structural surface features 22 increasing mechanical interlocking in the bonded joint 10.

The pattern 23 of the bond line 18 shown in FIG. 9 is now described in greater detail. The pattern 23 is “two-sided”, and is present on both the portion 16A′ of the second surface 16A of the second component 16 and on the portion 14A′ of the first surface 14A of the first component 14. The structural surface features 22 of the pattern 23 are protrusions extending outwardly from the second surface 16A toward the first surface 14A, and from the first surface 14A toward the second surface 16A. The protrusions are spaced apart from one another along the width W of the bond line 18. The protrusions are spaced apart from one another along some or all of the length L of the bond line 18. Channels are defined between the protrusions. The channels have a height measured from the portions 14A′,16A′ of the first and second surfaces 14A,16A to the top of the protrusions. The protrusions are arranged in parallel within the pattern 23. The protrusions on the second surface 16A are misaligned with the protrusions on the first surface 14A. The protrusions repeat throughout the pattern 23.

The pattern 23 of the bond line 18 shown in FIG. 10A is now described in greater detail. FIG. 10A is a top view of the second surface 16A of the second component 16 having the pattern 23. The pattern 23 is “one-sided”, and is present on only the portion 16A′ of the second surface 16A of the second component 16. The structural surface features 22 of the pattern 23 are surface protrusions 22A extending outwardly from the second surface 16A. The surface protrusions 22A are spaced apart from one another along the width W of the bond line 18. The surface protrusions 22A are spaced apart from one another along some or all of the length L of the bond line 18. Channels are defined between the surface protrusions 22A. The channels have a height measured from the portions 16A′ of the second surface 16A to the second ends 24B of the surface protrusions 22A. The surface protrusions 22A are arranged in parallel within the pattern 23. The surface protrusions 22A repeat throughout the pattern 23.

Referring to FIG. 10B, the second component 16 of FIG. 10A is shown in cross-section and bonded to the first component 14. The thickness TSP of each surface protrusion 22A of the second component 16 is substantially equal to the thickness T of the bond line 18. In FIG. 10B, the thickness TSP of each surface protrusion 22A is identical to the thickness T of the bond line 18 at the location of a given surface protrusion 22A. In FIG. 10B, the second end 24B of each surface protrusion 22A is abutted directly against the surface 14A of the first component 14. The thickness T of the bond line 18 between the first and second surfaces 14A,16A is substantially constant along the bond line 18. It is meant by “substantially constant” that the thickness T of the bond line 18 does not change between the first and second surfaces 14A,16A, or varies slightly by an acceptable manufacturing deviation. For example, and referring to FIG. 10B, the thickness T of the bond line 18 to the left of the surface protrusion 22A is 10.3 thou, and the thickness T of the bond line 18 to the right of the surface protrusion 22A is 10.9 thou. Thus, in FIG. 10B, the constant thickness T of the bond line 18 is about 10 thou and has been obtained without placing fillers and media into the bond line 18. Referring to FIG. 10B, the thickness TSP of each surface protrusion 22A is substantially equal to the thickness T of the bond line 18 and to the thickness of the cured adhesive 11. The portions of the second surface 16A that are between the surface protrusions 22A are spaced apart an equal distance from the first surface 14A.

Referring to FIG. 10B, the second component 16 includes a substrate 17 that defines the body of the second component 16. The substrate 17 may be made of any suitable material, for example composite materials, a metal material, or combinations or alloys thereof. In FIG. 10B, the substrate 17 is a metal material. In FIG. 10B, the substrate 17 is Aluminum or Titanium. The metal second component 16 is bonded to a composite first component 14. The second component 16 also includes a structural adhesive 19. The structural adhesive 19 is a solid object which defines or forms the surface structure 20, and is intended to provide structure to the bond line 18 to help control its thickness T. The structural adhesive 19 defines the surface structure 20 and is used to distance the first and second surfaces 14A,16A. In FIG. 10B, the structural adhesive 19 is a layer of cured epoxy resin. The structural adhesive 19 is shown in FIG. 10A as the outermost surface 16A of the second component 16. Referring to FIGS. 10A and 10B, the structural adhesive 19 is bonded to the metal substrate 17. The adhesive 11 is then subsequently applied to the cured structural adhesive 19 to bond the structural adhesive 19 (and thus the second component 16) to the first component 14. Thus, at least in the configuration shown in FIGS. 10A and 10B, the structural adhesive 19 functions to both define the surface structure 20 and to help bond the components 14,16 together, whereas the cured adhesive 11 serves to merely bond the components 14,16 together. The cured adhesive 11 may be a different material than the material of the structural adhesive 19. For example, in FIG. 10B, the structural adhesive 19 is a layer of cured epoxy resin, and the cured adhesive 11 is another resin with aluminum particle filler. The aluminum particle filter may be omitted from the cured adhesive 11.

Referring to FIG. 10B, the structural adhesive 19 is disposed on the substrate 17. The structural adhesive 19 is the portion of the surface structure 20 which defines the outermost and visible second surface 16A of the second component 16. The surface protrusions 22A extending outwardly from the second surface 16A are composed of the material of the structural adhesive 19. The surface protrusions 22A are formed from the material of the structural adhesive 19. The surface protrusions 22A are made from the material of the structural adhesive 19. The surface protrusions 22A are part of the structural adhesive 19. Thus, in FIG. 10B, the surface structure 20 of the second component 16 is a layer of solid adhesive 19 that is separate from, and applied on, the substrate 17 of the second component 16. It will thus be apparent that the surface structure 20 does not form part of the underlying geometry of the second component 16, and is applied to the substrate 17 to impact a property of the bond line 18. The application of the surface structure 20 composed of the structural adhesive 19 to the second component 16 leaves unchanged the underlying geometry and properties of the second component 16.

The pattern 23 of the bond line 18 shown in FIG. 11A is now described in greater detail. FIG. 11A is a top view of the second surface 16A of the second component 16 having the pattern 23. The pattern 23 is “one-sided”, and is present on only the portion 16A′ of the second surface 16A of the second component 16. The structural surface features 22 of the pattern 23 are surface protrusions 22A extending outwardly from the second surface 16A. The surface protrusions 22A are spaced apart from one another along the width W of the bond line 18. The surface protrusions 22A are spaced apart from one another along some or all of the length L of the bond line 18. Channels are defined between the surface protrusions 22A. The channels have a height measured from the portions 16A′ of the second surface 16A to the second ends 24B of the surface protrusions 22A. The surface protrusions 22A are arranged in parallel within the pattern 23. The surface protrusions 22A repeat throughout the pattern 23.

Referring to FIG. 11B, the second component 16 of FIG. 11A is shown in cross-section and bonded to the first component 14. The thickness TSP of each surface protrusion 22A of the second component 16 is substantially equal to the thickness T of the bond line 18. In FIG. 11B, the thickness TSP of each surface protrusion 22A differs slightly from the thickness T of the bond line 18 by an acceptable manufacturing deviation. For example, and referring to FIG. 11B, the second end 24B of the illustrated surface protrusion 22A is spaced apart from the first surface 14A a distance less than the thickness TSP of the surface protrusion 22A. For example, in FIG. 11B, the second end 24B of the surface protrusion 22A is spaced apart from the first surface 14A by about 1.4 thou, and the thickness TSP of the surface protrusion 22A is about 10 thou. The thickness T of the bond line 18 between the first and second surfaces 14A,16A is substantially constant along the bond line 18. It is meant by “substantially constant” that the thickness T of the bond line 18 does not change between the first and second surfaces 14A,16A, or varies slightly by an acceptable manufacturing deviation. For example, and referring to FIG. 11B, the thickness T of the bond line 18 to the left of the surface protrusion 22A is 12.9 thou, and the thickness T of the bond line 18 to the right of the surface protrusion 22A is 12.4 thou. Thus, in FIG. 11B, a constant thickness T of the bond line 18 is about 12 thou and has been obtained without placing fillers and media into the bond line 18. Referring to FIG. 11B, the width of the surface protrusion 22A is about 90.9 thou, and the thickness TSP of the surface protrusion 22A is substantially equal to the thickness T of the bond line 18 and to the thickness of the cured adhesive 11. The portions of the second surface 16A that are between the surface protrusions 22A are spaced apart an equal distance from the first surface 14A.

Referring to FIG. 11B, the second component 16 includes a substrate 17 that defines the body of the second component 16. The substrate 17 is a composite material. In FIG. 11B, the substrate consists of carbon fiber plies 17A impregnated with epoxy resin 17B, giving the appearance of a “sandwich” structure for the substrate 17 with alternating layers of carbon fiber plies 17A and resin 17B. Some non-limiting examples of other materials for the fiber plies 17A include glass and aramid. Some non-limiting examples of other materials for the resin 17B include other thermosets such as bismaleimide (BMI) or thermoplastic. The composite substrate 17 may be a thermoplastic. In FIG. 11B, the composite substrate 17 of the second component 16 is bonded to a composite first component 14. The second component 16 also includes the structural adhesive 19, similar to as described above. In FIG. 11B, the structural adhesive 19 is one of the cured layers of resin 17B. In FIG. 11B, the structural adhesive 19 is the outermost layer of cured resin 17B. The structural adhesive 19 is shown in FIG. 11A as the outermost surface 16A of the second component 16.

Referring to FIG. 11B, the structural adhesive 19 is disposed on one of the fiber plies 17A of the substrate 17. The structural adhesive 19 is the portion of the surface structure 20 which defines the outermost and visible second surface 16A of the second component 16. The surface protrusions 22A extending outwardly from the second surface 16A are composed of, formed from, and/or made from the material of the structural adhesive 19. Thus, in FIG. 11B, the surface protrusions 22A are formed from the outermost layer of cured resin 17B. The surface protrusion 22A is formed from an epoxy of the outermost layer of cured resin 17B, and there is no separate resin layer applied to the cured composite substrate 17 to form the surface protrusions 22A. The surface protrusions 22A may be formed from the outermost layer of cured resin 17B while the second component 16 is being manufactured (i.e. “in-process”), or after the second component 16 has been manufactured (i.e. “post-process”). In FIG. 11B, the surface structure 20 of the second component 16 is a layer of solid adhesive 19 that is separate from a remainder of the fiber plies 17A and the remainder of the cured resins 17B of the substrate 17 of the second component 16. It will thus be apparent that the surface structure 20 does not form part of the underlying geometry of the second component 16, and is applied to the substrate 17 to impact a property of the bond line 18. The application of the surface structure 20 to the second component 16 leaves unchanged the underlying geometry and properties of the second component 16.

The pattern 23 of the bond line 18 shown in FIG. 12 is now described in greater detail. The pattern 23 is “one-sided”, and is present on only the portion 16A′ of the second surface 16A of the second component 16. The structural surface features 22 of the pattern 23 are surface protrusions 22A extending outwardly from the second surface 16A. The surface protrusions 22A are spaced apart from one another along the width W of the bond line 18. The surface protrusions 22A are spaced apart from one another along some or all of the length L of the bond line 18. Channels are defined between the surface protrusions 22A. The channels have a height measured from the portions 16A′ of the second surface 16A to the second ends 24B of the surface protrusions 22A. The surface protrusions 22A are arranged in parallel within the pattern 23. The surface protrusions 22A repeat throughout the pattern 23.

Referring to FIG. 12, the second component 16 includes a substrate 17 that defines the body of the second component 16. The substrate 17 is a metal material. In FIG. 12, the substrate 17 is Aluminum or Titanium. The metal second component 16 is bonded to a metal first component 14. The second component 16 also includes a structural metal material 19A. The metal material 19A is a solid object which defines or forms the surface structure 20, and is intended to provide structure to the bond line 18 to help to control its thickness T.

Referring to FIG. 12, the metal material 19A is disposed on the substrate 17. The metal material 19A is the portion of the surface structure 20 which defines the outermost and visible second surface 16A of the second component 16. The surface protrusions 22A extending outwardly from the second surface 16A are composed of, formed from, and/or made from the metal material 19A. The surface protrusions 22A may be formed by machining, cutting or lasering the metal material 19A to form grooves in the metal material 19A that define the surface protrusions 22A. The metal material 19A is thus a sacrificial layer or element of the second component 16 which is intended to be modified to impart the desired surface structure 20 to the second component 16 without affecting the remainder of the second component 16 (i.e. the substrate 17). Thus, in FIG. 12, the surface structure 20 of the second component 16 is a layer of metal material 19A that is separate from, and applied on, the metal substrate 17 of the second component 16. It will thus be apparent that the surface structure 20 does not form part of the underlying geometry of the second component 16, and is applied to the substrate 17 to impact a property of the bond line 18. The application of the surface structure 20 to the second component 16 leaves unchanged the underlying geometry and properties of the second component 16. The description above with respect to FIG. 12 applies mutatis mutandis to a configuration of the bonded part 9 where the second component 16 includes a substrate 17 made of composite material that is bonded to a first component 14 that is also a composite material.

It will therefore be appreciated that the structural surface features 22 and/or the pattern 23 may be selected to affect or impact different desired properties of the bond line 18. Yet another possible property of the bond line 18 that may be impacted by the pattern 23 is adhesive wetting on the one or more mating surfaces, which may be increased by increasing the amount of surface area of the one or more mating surfaces exposed to the adhesive 11. Thus, the selected surface pattern 23 may allow for controlling the geometry of the bond line 18 at the interface of the components 12, controlling the thickness T of the bond line 18, improving alignment of the mating surfaces, increasing adhesive wetting on one or both of the mating surfaces, increasing or decreasing the flow of adhesive 11 through the bond line 18, and/or improving mechanical adhesion. The surface pattern 23 may allow for removing or avoiding objects in the bond line 18, such as media like glass beads, which are typically used to provide some properties to the bond line 18. Such conventional objects may introduce contamination into the bond line 18, or allow for its introduction. The surface pattern 23 may allow for using fasteners in the bond line 18, which is often not possible or recommended when permanent media such as glass beads are present in conventional bond joints.

Referring to FIG. 6A, there is disclosed a method of bonding the components 12 along the bond line 18. The method includes providing the surface structure 20 with the surface protrusions 22A on one or both of the first and second surfaces 14A,16A of the bond line 18. The method includes applying the adhesive 11 along the bond line 18 between the first and second surfaces 14A,16A. The method includes joining the first and second surface surfaces 14A,16A together along the bond line 18 to wet both the first and second surfaces with the adhesive 11. The method includes curing the adhesive 11 between the joined first and second surfaces 14A,16A to bond the components 12 along the bond line 18.

In one possible configuration, only one of the components 12 is provided with the surface structure and has a film bonded onto its mating surface and surface structure 20. This film-bonded surface is then prepared to be bonded to the other component 12. Such a joint may be referred to as a composite bond involving two steps and two applications of adhesive 11.

In one possible configuration of the method, the surface structure 20 is provided to the mating surface during manufacturing of the components 12. This may be referred to as applying the surface structure 20 “in-process”, i.e. while the component 12 is being formed or made. The desired surface structure 20 may be applied during part of component fabrication using any suitable technique, some of which are described in greater detail below.

Some possible techniques for forming the surface structure 20 on composite components 12 during part or component fabrication are now described. One possible technique involves applying a removable media to one or both of the first and second surfaces 14A,16A to form the desired surface structure 20, removing the media from the first or second surfaces 14A,16A after forming the surface structure 20, and then curing the components 12 (e.g. in the embodiment where they are composite materials) to form the surface structure 20. Such a removable media may include placing a grid, cloth, mesh, or peel ply on the desired mating surface to create the desired surface design. The media does not form part of the fabricated component 12. The media in this technique does not include glass beads, or other media which would remain part of the fabricated component or the bonded joint 10. Another possible technique involves adding material to, or removing material from, one or both of the first and second surfaces 14A,16A, such as the structural adhesive 19, and co-curing the structural adhesive 19 with the composite components 12 to form the surface structure 20. This may involve creating the desired protrusions or grooves described above.

Referring to FIG. 13, yet another possible technique for forming the surface structure 20 involves pressing a specialised forming tool 50, such as a textured caul plate, which has a textured surface representative of the pattern 23 of structural surface features 22, against the first and/or second surfaces 14A,16A to imprint the pattern 23, and curing the composite components 12 to form the surface structure 20. Such a tool 50 may have an imprint pattern that is opposite to, or the inverse of, the desired pattern 23 to be imprinted on the mating surface. One possible tool 50 is shown in FIG. 13, and includes multiple grooves 52 which are spaced apart from each other by the optional dimensions shown, and which form the surface protrusions 22A when the illustrated face of the plate 50 is applied with pressure against the mating surface 14A,16A of the component 14,16. Another possible technique for forming the surface structure 20, which may be suitable for components 12 made of metal, includes adding material to one or both of the first and second surfaces 14A,16A using additive manufacturing, or adding the sacrificial metal material 19A.

One possible configuration for making the surface structure 20 from the structural adhesive 19 includes adding a resin or a film epoxy onto the substrate 17 such that the resin/film defines the first surface 14A, and then forming the surface protrusions 22A from the resin/film, and curing the surface protrusions 22A and the resin/film to form the structural adhesive 19 layer. The adhesive 11 used for bonding the components 12 together is then subsequently applied to the structural adhesive 19 and its first surface 14A, and/or to the second surface 16A. The tool 50 may be used to form the surface protrusions 22A in the resin/film.

After the surface structure 20 and the component 12 have been formed together, the method may involve preparing, or “prepping”, the mating surface using one or more of the following techniques: etching, sandblasting, and hand sanding. This may further prepare the portion of the mating surface for bonding with the other component. Some of these preparation techniques may be more suitable than others, depending on the scale of the pattern 23 and the structural surface features 22.

In another possible configuration of the method, the surface structure 20 is provided to the mating surface after the components 12 have been manufactured. This may be referred to as applying the surface structure 20 “post-process”, i.e. after the component 12 part has been made. The desired surface structure 20 may be applied after component fabrication using any suitable technique, some of which are described in greater detail below.

Some possible techniques for forming the surface structure 20 on the components 12 after fabrication of the component 12 are now described. One possible technique includes forming the surface structure 20 with one or both of etching and machining the first and/or second surfaces 14A,16A to form the surface protrusions 22A arranged in the pattern 23. In configurations where the component 12 is made of metal, a mesh may be used to perform the etching. Another possible technique includes forming the surface structure 20 with lasering, or laser cutting, the first and/or second surfaces 14A,16A to form the surface protrusions 22A arranged in the pattern 23. In such a technique, the laser may perform a first pass to achieve the desired pattern 23, and may then subsequently complete a second pass to prepare the mating surface for bonding.

After the surface structure 20 has been provided to the already-made component 12, the method may involve preparing, or “prepping”, the mating surface using one or more of the following techniques: etching, sandblasting, laser ablation, and hand sanding. This may further prepare the portion of the mating surface for bonding with the other component. Some of these preparation techniques may be more suitable than others, depending on the scale of the pattern 23 and the surface protrusions 22A. In an embodiment, the surface structure 20 provided on the already-made component 12 does not require further preparation, and may be bonded without further processing. In an alternative embodiment, the surface pattern 23 may be applied on the already-made component 12 at the same time as performing the surface preparation.

Referring to FIG. 6A, there is disclosed a method of preparing the mating surface of the component 12 to be bonded with another surface of another component 12 along the bond line 18. The method includes selecting structural surface features 22, such as the surface protrusions 22A, for the surface. The surface protrusions 22A may be selected by choosing a sheet media, choosing a laser cutting pattern, or choosing an additive manufacturing pattern, etc. to achieve the desired pattern 23 and impact a property of the bond line 18. The impact that is selected is typically an improvement or optimisation, or to impart a desired value for the property of the bond line 18, such as its thickness T. The method includes providing the structural surface features 22 onto an area of the mating surface, such as by using one or more of the “in-process” or “post-process” techniques described above.

The bonded joint 10 and methods disclosed herein may allow for improved cycle times and provide cost savings. The bonded joint 10 and methods may help to control the properties of the bond line 18, such as its thickness T, without having to use traditional process which are more labour intensive, manual and not repetitive. The bond line 18 is formed without permanent media, and may thus be more continuous and have fewer stress concentrations. The bonded joint 10 and methods allow for avoiding the addition of permanent media to the bond line 18, which prior to its addition, needs to be purchased, controlled through spec, stored and processed. The bonded joint 10 and methods allow for removing or avoiding complex tooling which is conventionally used to control the gap with an arresting feature. The bonded joint 10 and methods allow for controlling the quantity of adhesive 11 used and for removing permanent media, which may allow for optimizing the bonded joint 10 and reducing its weight. The bonded joint 10 and methods allow for using fasteners in the bond line 18.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A method of bonding components along a bond line, the bond line formed along a first surface of one of the components and a second surface on another one of the components facing the first surface, the method comprising:
providing a surface structure on the first surface of the bond line, the surface structure having a plurality of surface protrusions arranged in a pattern and occupying an area of the first surface, each of the surface protrusions protruding outwardly from a first end at the first surface to a second end, a thickness of the surface protrusions defined between the first and second ends;
applying an adhesive on one or both of the first and second surfaces along the bond line;
joining the first and second surface surfaces together to bring the second ends of the surface protrusions in proximity to the second surface, the adhesive defining a thickness of the bond line being substantially equal to the thickness of the surface protrusions; and
curing the adhesive between the joined first and second surfaces to bond the components along the bond line.

2. The method of claim 1, wherein providing the surface structure includes forming the surface structure on the first surface during manufacturing of the components.

3. The method of claim 2, wherein forming the surface structure includes adding material to define the first surface and the surface protrusions, and curing the components to form the surface structure.

4. The method of claim 2, wherein forming the surface structure includes adding material to define the first surface, and removing some of the added material to form the surface protrusions.

5. The method of claim 2, wherein forming the surface structure includes pressing a tool having a textured surface representative of the pattern of the surface protrusions against the first surface, and curing the components to form the surface structure.

6. The method of claim 2, comprising preparing the first surface after forming the surface structure by one or more of etching, sandblasting, laser ablation, and hand sanding.

7. The method of claim 1, wherein providing the surface structure includes forming the surface structure on the first surface after having manufactured the components.

8. The method of claim 7, wherein forming the surface structure includes one or more of etching, lasering, and machining the first surface to form the surface protrusions arranged in the pattern.

9. The method of claim 7, wherein forming the surface structure includes adding material to define the first surface and the surface protrusions, and curing the components to form the surface structure.

10. The method of claim 7, comprising subsequently preparing the first surface after forming the surface structure by one or more of etching, sandblasting, and hand sanding.

11. The method of claim 1, wherein forming the surface structure includes adding a resin onto a substrate of the one of the components such that the resin defines the first surface, forming the surface protrusions from the resin, and curing the surface protrusions.

12. A method of preparing a surface of a component to be bonded with another surface of another component along a bond line, the method comprising: selecting a pattern of surface protrusions for the surface to define a thickness of the bond line; and providing the surface protrusions onto an area of the surface within the bond line.

13. A bonded part, comprising:
a first component having a first surface facing toward a second surface of a second component;
a cured adhesive between the first and second surfaces and defining a bond line, a thickness of the bond line defined between the first and second surfaces;
a surface structure on the first surface within the bond line, the surface structure having a plurality of surface protrusions arranged in a pattern and occupying an area of the first surface, each of the surface protrusions protruding outwardly from a first end at the first surface to a second end adjacent to the second surface, a thickness of the surface protrusions defined between the first and second ends and being substantially equal to the thickness of the bond line; and
the cured adhesive extending around the surface protrusions, the thickness of the bond line between the first and second surfaces being substantially constant along the bond line, and being greater than a thickness of the cured adhesive between the second ends of the protrusions and the second surface.

14. The bonded part of claim 13, wherein the thickness of the surface protrusions is substantially constant over the area of the first surface.

15. The bonded part of claim 13, wherein the second end of one or more of the surface protrusions abuts against the second surface.

16. The bonded part of claim 13, wherein the second end of one or more of the surface protrusions is spaced apart from the second surface a distance less than the thickness of the surface protrusion.

17. The bonded part of claim 13, wherein the first component includes a substrate and a structural adhesive disposed on the substrate and defining the first surface, the surface protrusions made of the structural adhesive.

18. The bonded part of claim 17, wherein the substrate includes one or more fiber plies and the structural adhesive is a cured resin disposed on an outer-most fiber ply of the substrate.

19. The bonded part of claim 13, wherein the first component includes a metal substrate and a metal material disposed on the metal substrate and defining the first surface, the surface protrusions made of the metal material.

20. The bonded part of claim 13, wherein the surface structure and the surface protrusions are only disposed on the first surface.

21. The bonded part of claim 13, wherein each of the surface protrusions is a cylinder.
